(19) United States
(12) Patent Application Publication
(10) Pub. No.: US 2015/0090719 A1
(43) Pub. Date: Apr. 2, 2015

(54) Animal-Proof Locking Mechanism For Trash Containers

(71) Applicant: Kathi Lyon, Boca Raton, FL (US)

(72) Inventor: Kathi Lyon, Boca Raton, FL (US)

(21) Appl. No.: 14/503,044

(22) Filed: Sep. 30, 2014

Related U.S. Application Data
(60) Provisional application No. 61/884,988, filed on Sep. 30, 2013.

(51) Int. Cl. B65F 1/14

(52) U.S. Cl. CPC B65F 1/1615
USPC 220/323; 220/324

(57) ABSTRACT

A quick disconnect lock for a trash container. A snaplock secures on one end to a U-Bolt on the hinged lid of a trash container, and is secured at the other end to a second U-Bolt attached to the wall of the trash container.

### CROSS-REFERENCE TO RELATED APPLICATIONS

This application is related to, and claims the benefit of, the provisional patent application entitled “Animal-Proof Locking Mechanism For Trash Containers”, filed Sep. 30, 2013, bearing U.S. Ser. No. 61/884,988 and naming Kathi Lyon, the named inventor herein, as sole inventor, the contents of which is specifically incorporated by reference herein in its entirety.

### BACKGROUND

1. Technical Field

This invention relates in general to trash disposal containers, and more particularly it relates to trash containers with animal-roof quick disconnect locking mechanisms to prevent animals from accessing the trash container prior to trash pickup.

2. Background of the Invention

A frequent problem associated with prior art trash containers is their vulnerability to access by animals. In particular, many animals find trash containers to be rich sources of food. Unfortunately, they also tend to spread the garbage in a garbage container such that a substantial litter problem is created by the animal in its quest for food. Quite often, larger animals will tip a trash container over such that the trash is spread over a wide area.

For some individuals, their trash container is left outside of the home most of the time. This creates a magnet for animals seeking food on a daily basis. Likewise, even individuals having the ability to keep trash containers inside a garage or other enclosed storage area must still leave the trash container out for pickup. Often, this would be done in the evening before trash collection to ensure that the trash collection is not missed. It would be desirable to have a method of preventing animals from accessing trash containers without causing the animal any harm.

Prior art attempts to secure trash containers typically use complicated systems which greatly increase the cost of the trash container. Further, these systems are often unwieldy and inconvenient for the user. It would be desirable to have and inexpensive and uncomplicated mechanism for securing trash containers. Further, it would be advantageous to have a method of quickly and easily securing and unsecuring trash containers with a minimum of time and effort.

Another problem associated with prior art trash container securing devices is that they are incompatible with modern semi-automated trash collection systems which use power lift systems to lift and unload a trash container. These containers would not be operable in areas where semi-automated trash collection systems are used.

While the prior art has provided cumbersome and complicated trash container locking devices, it has failed to provide a convenient and easy-to-use locking mechanism that is suitable for use with modern automated trash pickup systems.

### SUMMARY OF THE INVENTION

This invention provides a quick disconnect lock that can be manufactured as part of a new trash container, or alternatively, be retrofitted to a prior art trash container. The invention uses a snaplock that secures on one end to a U-Bolt on the hinged lid of a trash container, and is secured at the other end to a second U-Bolt attached to the wall of the trash container such that it does not interfere with trash pickup by semi-automated trash collection equipment.

### BRIEF DESCRIPTION OF THE DRAWINGS

FIG. 1 is a side view of a prior art trash container with lid in the closed configuration.

FIG. 2 is a side view of a prior art trash container with the lid in the open configuration.

FIG. 3 is a front sectional view of a trash container with the locking mechanism securing the lid to the body of the trash container.

FIG. 4 is a side sectional view of a trash container with the locking mechanism securing the lid to the body of the trash container.

FIG. 5 is a side sectional view of a trash container with the locking mechanism in the unlocked position, such that the lid can freely move on its hinge for unloading.

FIG. 6 is a side sectional view of a trash container with an alternative locking mechanism in the locked position. This embodiment uses a bayonet type locking arrangement with a quick release button.

### DETAILED DESCRIPTION OF THE PREFERRED EMBODIMENT

Prior to a discussion of the figures, an overview of the invention will be presented. The invention is a quick disconnect locking mechanism that uses a snaplock that secures to opposing U-Bolts. A U-Bolt attached to the trash container is secured to the proximal end of the snaplock, and a second U-Bolt attached to the lid of the trash container at the distal end of the snaplock.

The trash container is secured by securing the snaplock to the U-Bolts on the trash container and on the trash container lid. The user can conveniently secure the trash container during normal use, and easily disconnect one end of the snaplock prior to trash pickup such that a trash container can only be opened during a very limited time window, thereby discouraging animals from dumping the trash while they are in search of food.

An important feature of the invention is that it is designed so as not to interfere with modern semi-automated trash collection vehicles that use power left mechanisms to lift and empty trash containers into a trash collection vehicle. The problem associated with prior art securing devices for trash containers is that they are typically cumbersome and incompatible with modern semi-automated trash collection vehicles.

Having discussed the invention in general, we turn now to a detailed discussion of the drawings.

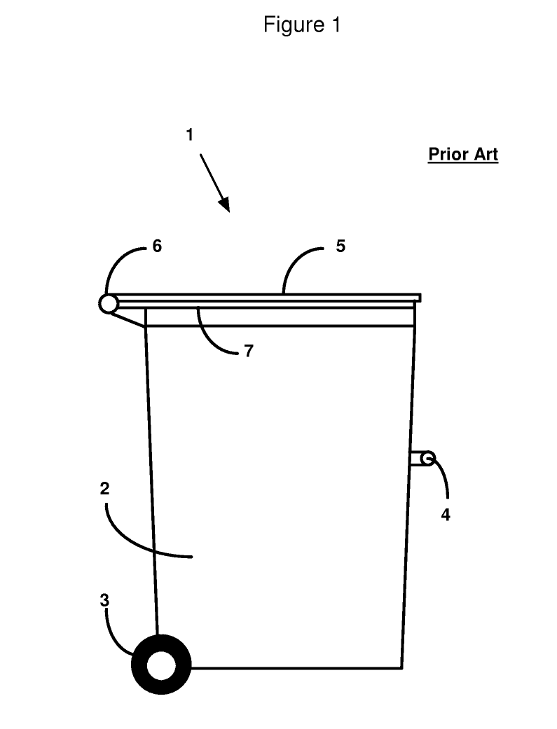

FIG. 1 is a side view of a prior art trash container 1 with lid 5 in the closed configuration. The lid 5 is hingedly attached to the trash container body 2 by hinge 6 that allows the lid 5 to swing open when the trash container 1 is lifted by lift handle 4 under control of a trash removal vehicle. Also shown are wheels 3 typically found on modern trash containers 1.

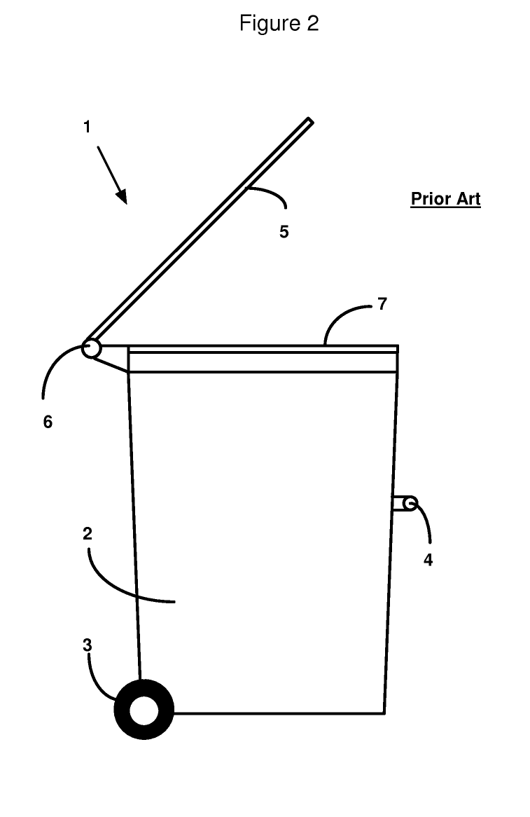

FIG. 2 is a side view of a prior art trash container 1 with the lid 5 in the open configuration. During trash pickup, a trash collection vehicle will lift up trash container 1 by lift handle 4 and tilt it to dump the trash into the trash collection vehicle. When this happens, the lid 5 will swing open on hinge 6 to allow the trash to empty.

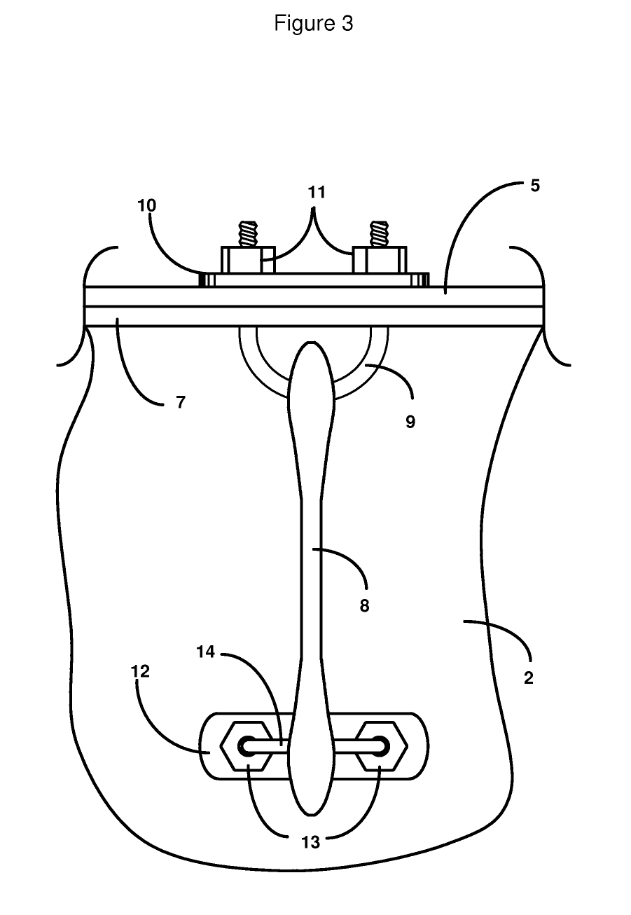

FIG. 3 is a front sectional view of a trash container 1 with the locking mechanism securing the lid 5 to the body 2 of the trash container 1. The locking mechanism consists of a snaplock 8 that secures to a U-Bolt 14 at its proximal end, and also secures to a second U-Bolt 9 at its distal end. U-Bolts 9 and 14 are secured to lid 5 and trash container body 2 via plates 10 and 14 respectively. U-Bolts 9 and 14 are further secured to plates 10 and 12, respectively, by nuts 11 and 13. For ease of illustration nuts 13 are illustrated outside of the trash container body 2. However, in practice the nuts will preferably be positioned inside of the trash container body 2.

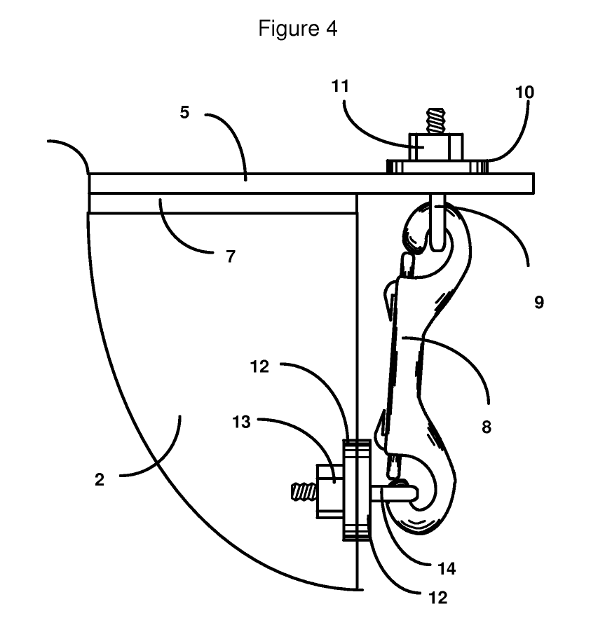

FIG. 4 is a side sectional view of a trash container 1 with the locking mechanism securing the lid 5 to the body 2 of the trash container 1. This figure better illustrates the preferred placement of nuts 13 inside of the trash container body 2. In practice, the user only needs to disconnect one end of the snaplock 8 to release the lid 5 such that the trash container number one can be emptied. Either end of snaplock 8 can be disconnected.

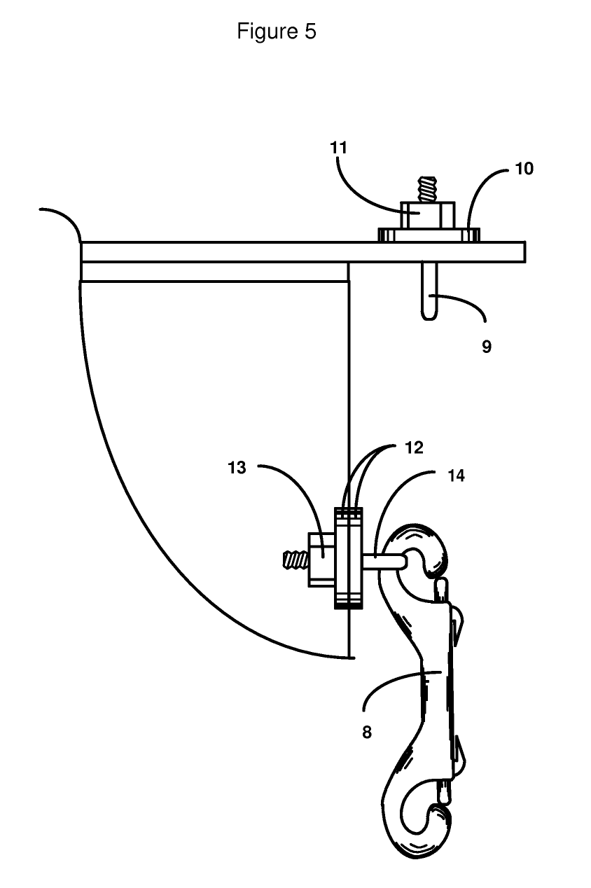

FIG. 5 is a side sectional view of a trash container 1 with the locking mechanism in the unlocked position, such that the lid 5 can freely move on its hinge 6 for unloading. An important advantage of the present invention is that when in the unlocked position, the locking mechanism will not interfere with the unloading of trash by a semi-automated trash removal vehicle. This solves a problem associated with prior art trash container securing systems that are incompatible with modern semi-automated trash removal vehicles.

The U-Bolt's act as connection points for the snaplock 8. Further, the snaplock 8 is a locking connector that secures the two connection points in relation to one another. Those skilled in the art will recognize that alternatives to the snaplock 8 can be used. Likewise, alternatives to the U-Bolt structure can also be used.

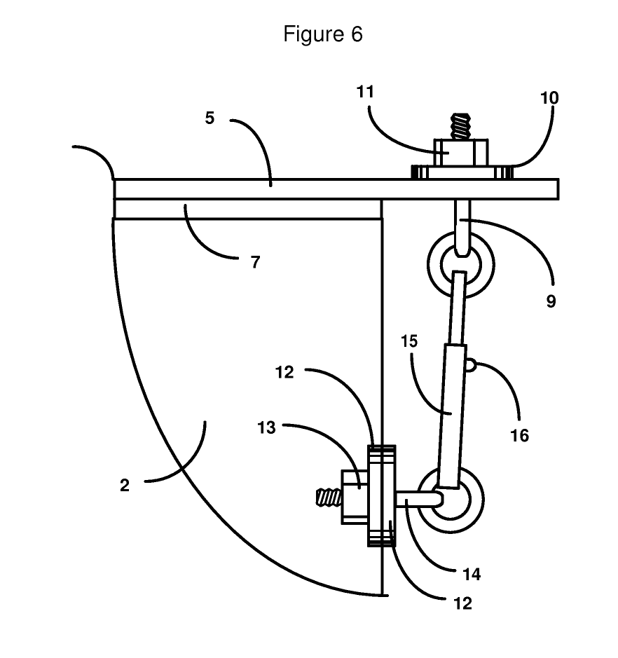

FIG. 6 is a side sectional view of a trash container with an alternative locking mechanism in the locked position. This embodiment uses a bayonet-type locking arrangement 15 with male and female portions, and with a spring-loaded quick release button 16. When the male and female portions are joined, they are held together by the spring-loaded quick release button 16. Prior to arrival of the trash removal vehicle, the male and female portions are disconnected by pressing the spring-loaded quick release button 16 and pulling the two portions apart.

While specific embodiments have been discussed to illustrate the invention, it will be understood by those skilled in the art that variations in the embodiments can be made without departing from the spirit of the invention. The types of quick disconnect locks can vary, the size and shape of a locking mechanism can vary so long as it does not interfere with operation of the trash collection vehicle, the materials used to construct the locking mechanism can vary, etc. Therefore, the invention shall be limited solely to the scope of the claims.

I Claim:

1. A trash container locking mechanism, comprising:
a first connection point for attachment to the body of a trash container;
a second connection point for attachment to the lid of a trash container;
a locking connector having a distal end suitable for attachment to the first connection point, and a proximal and suitable for attachment to the second connection point;
the locking connector detachably attaching to the first and second connection points such that when attached, the lid is secured to the body of the trash container, and when detached, lid is movable in relation to the body of the trash container;
whereby the lid out the trash container can be secured or unsecured by attachment or detachment of the locking container.

2. A locking mechanism, as in claim 1, wherein:
the first and second connection points are u-bolts.

3. A locking mechanism, as in claim 2, wherein:
the locking connector is a snaplock.

4. A locking mechanism, as in claim 3, wherein:
the snaplock is sized such that when disconnected from one of the u-bolts, the trash container lid is not interfered with when the trash container is emptied.

5. A locking mechanism, as in claim 2, wherein:
the locking connector is a bayonet-type connector, having a female portion and a male portion;
a spring-loaded locking button on the male portion of the connector and a button retention aperture on the female portion of the connector which cooperate to.

6. A locking mechanism, as in claim 5, wherein:
the bayonet-type connector is sized such that when the male and females portions are disconnected, the trash container lid is not interfered with when the trash container is emptied.
